(19) United States
(12) Patent Application Publication
(10) Pub. No.: US 2008/0050616 A1
(43) Pub. Date: Feb. 28, 2008

(54) Method of manufacturing magnetic layer, patterned magnetic recording media including magnetic layer formed using the method, and method of manufacturing the same

(75) Inventors: Myung-bok Lee, Yongin-si (KR); Jin-seung Sohn, Yongin-si (KR); Byung-kyu Lee, Yongin-si (KR); Du-hyun Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/713,730

(22) Filed: Mar. 5, 2007

(30) Foreign Application Priority Data
Aug. 22, 2006 (KR) 10-2006-0079470

(51) Int. Cl. G11B 5/66; B05D 5/12

(52) U.S. Cl. 428/827; 427/128

(57) ABSTRACT

Provided are a method of manufacturing a magnetic layer, a patterned magnetic recording medium including magnetic layers formed using the method, and a method of manufacturing the patterned magnetic recording medium. The method of manufacturing the magnetic layers includes: forming a template provided with an opening; forming a seed layer on a bottom of the opening; and inserting a magnetic material onto the seed layer to form a magnetic layer. The patterned magnetic recording medium includes a lower layer formed on a substrate; a template formed on the lower layer and including a plurality of holes exposing the lower layer; seed layers covering the lower layer exposed through the holes; and magnetic layers formed on the seed layers to fill the holes.

### CROSS-REFERENCE TO RELATED PATENT APPLICATION

This application claims the benefit of Korean Patent Application No. 10-2006-0079470, filed on Aug. 22, 2006, in the Korean Intellectual Property Office, the disclosure of which is incorporated herein in its entirety by reference.

### BACKGROUND OF THE INVENTION

1. Field of the Invention

The present invention relates to a magnetic recording medium and a method of manufacturing the same, and more particularly, to a method of manufacturing a magnetic layer, a patterned magnetic recording medium including thus formed magnetic layer formed using the method, and a method of manufacturing the same.

2. Description of the Related Art

Demands for magnetic recording media having a high recording density have been recently increased with increases in the amount of information recorded.

The increase in the recording density of the magnetic recording media means that information recording areas, i.e., bit sizes are reduced. When data is read from the magnetic recording media, magnetic signals generated from the magnetic recording media become weak due to the reductions in the bit sizes. Therefore, it is necessary to remove noise from the magnetic recording media to have high signal-to-noise ratios (SNRs) during playback.

Noise is mainly generated from transition parts which are defined by two consecutive or neighboring magnetic domains. Thus, noise may be reduced by decreasing the widths of the transition parts. Since the widths of the transition parts are proportional to the sizes of magnetic grains, which constitute bits, high SNRs may be obtained by reducing the sizes of the magnetic grains. However, the reduction in the sizes of the magnetic grains deteriorates thermal stabilities of the magnetic grains, which causes decreases in reliability of the magnetic recording media including the magnetic grains.

Therefore, there are limits to improving a recording density of a magnetic recording medium including consecutive magnetic domains each having tens to hundreds of magnetic grains. As an attempt to develop a new magnetic recording system free from such shortcomings, patterned magnetic recording media have been proposed. Patterned magnetic recording media include a magnetic film which is not a continuous film, but is in the pattern of various shapes such as dot or pillars. Thus, magnetic domains are structurally isolated from one another, and each of the magnetic domains operates as a magnetic grain.

In the patterned magnetic recording media, the magnetic domains are isolated from one another by nonmagnetic materials, which allows minimization of transition noise. Also, bit sizes of the patterned recording media are smaller than those of other types of existing magnetic recording media. As each of bits of the patterned recording media is comprised of a single magnetic grain, effective sizes of the magnetic grains are lager than those of the other types of existing magnetic recording media. Thus, it is possible to avoid the deterioration of thermal stability due to increases in recording densities.

Magnetic layers of the patterned recording media, where data is recorded, are formed by inserting a magnetic metal into holes in a template layer using a sputtering method or an electroplating method. The template layer provides a pattern of the magnetic layers. However, it is difficult to fill the holes with the magnetic layer using the sputtering method. This is because opening of the holes is clogged during the filling of the holes. The electroplating method may perform better in filling the holes, compared to the sputtering method.

However, magnetic recording media produced using the electroplating method may have the following drawbacks.

As shown in FIG. 1, in which reference numerals 110 and 120 denote a soft magnetic layer and an interlayer, respectively, and reference numeral 140a denotes a template which provides a pattern of the magnetic layers 150, thicknesses of patterned magnetic layers 150 may vary depending on areas of a substrate 100. The variance becomes greater as the aspect ratio of holes H is increased. In a worse case, it may occur that some holes remain unfilled. Also, the resulting magnetic layers 150 may not have a preferred orientation toward a magnetization-easy axis. This causes the magnetic layers 150 to have only shape magnetic anisotropic effects, but not crystallization magnetic anisotropic effects. Therefore, it is difficult to obtain patterned magnetic layers having good magnetization reverse characteristics. While the magnetization reverse characteristics may be improved by increasing the aspect ratios of the magnetic layers 150, which requires an increase of the aspect ratios of the holes H, such an increase of the aspect ratios of the holes will cause the same or similar problems discussed above.

In another effort to provide an advanced magnetic recording media, there has been suggested a method of producing magnetic recording media in which nano-holes are formed using an anodic aluminum oxidization and filled with a magnetic material such as Co, Fe, or Ni using an electroplating method. However, this method also has the above-described problems.

### SUMMARY OF THE INVENTION

The present invention provides a method of manufacturing magnetic layers of uniform thicknesses, which have vertical magnetic anisotropic properties, and each are comprised of a single magnetic domain. The method allows the adjusting of crystallization orientations.

The present invention also provides a patterned magnetic recording medium including magnetic layers formed using the method.

The present invention also provides a method of manufacturing the patterned magnetic recording medium.

According to an aspect of the present invention, there is provided a method of manufacturing a magnetic layer, including: forming a template provided with an opening, said template having an upper and a lower surface and a thickness; forming a seed layer on a bottom of the opening, said seed layer having a thickness which is smaller than the depth of the opening; and inserting a magnetic material onto the seed layer in the opening to form a magnetic layer.

The opening may be a through hole.

The seed layer may be formed of a magnetic material selected from the group consisting of CoP, CoB, NiP, and NiB, or a nonmagnetic material selected from the group consisting of Cu, Ag, Au, Ni, and Pd.

The seed layer may be formed to have a thickness between 1 nm and 30 nm. It also may be a multilayer.

The magnetic layer may be formed of CoNiP, CoPt, CoPtP, CoPtB, CoCrPt, CoCrTa, or CoCrNb.

The magnetic layer may be formed of Co/Pt or Co/Pd.

The magnetic layer may be formed of CoPt or FePt having an L1₀ structure.

The magnetic layer may be formed to a thickness between 10 nm and 100 nm.

Magnetic anisotropic energy of the magnetic layer may be greater than that of the seed layer.

The seed layer may have a plane which is parallel with the upper surface of the template (or a substrate in a magnetic recording medium including a substrate) and has a hexagonal close packed (HCP) (002) or face centered cubic (FCC) (111) orientation.

The magnetic layer may have an HCP structure and include a plane which is parallel with the upper surface of the template (or a substrate in a magnetic recording medium including a substrate) and <002>—preferred oriented.

The seed layer may be formed using an electroless plating method.

The magnetic layer may be formed using an electroplating method.

When the magnetic layer is formed, a magnetic field may be applied in a direction perpendicular to the bottom surface of the opening.

Prior to forming of the seed layer, a catalytic nucleus may be formed on the bottom of the opening to catalyze the formation of the seed layer. The catalytic nucleus may be a noble metal.
According to another aspect of the present invention, there is provided a magnetic recording medium including: a substrate having a upper surface, a lower surface, and a thickness; a lower layer formed on the upper surface of the substrate; a template formed on the lower layer and comprising a plurality of holes which expose parts (“exposed parts”) of the lower layer; seed layers which each cover the exposed parts of the lower layer, said seed layers having a thickness which is smaller than height of the holes; and magnetic layers formed on the seed layers in the holes, said magnetic layers filling the holes.
   The substrate may be a silicon substrate, a glass substrate, or an aluminum alloy substrate.

The seed layers may be formed of a magnetic material selected from the group consisting of CoP, CoB, NiP, and NiB, or a nonmagnetic material selected from the group consisting of Cu, Ag, Au, Ni, and Pd.

The lower layer may be a laminate layer in which a soft magnetic layer and an interlayer are stacked in turn.

The interlayer may be formed of Ti, Ru, Pt, Cu, or Au.

The lower layer may have an HCP or FCC structure.

The interlayer may have an HCP structure having a (002) plane which is parallel with the upper surface of the substrate.

The interlayer may have an FCC structure having a (111) plane which is parallel with the upper surface of the substrate.

In one exemplary embodiment, the seed layers are formed of the nonmagnetic material, and the lower layer is a soft magnetic layer.

The seed layers may have a thickness between 1 nm and 30 nm.

The seed layers may have a plane which is parallel with the upper surface of the substrate and is HCP (002)-oriented or FCC (111)-oriented.
The magnetic layers may be formed of CoNiP, CoPt, CoPtP, CoPtB, CoCrPt, CoCrTa, or CoCrNb.

The magnetic layers may be a multilayer formed of Co/Pt or Co/Pd.

The magnetic layers may be formed of CoPt or FePt, which has an LiO structure.

The magnetic layers may have a thickness between 10 nm and 100 nm.

The magnetic layers may have an HCP structure and a plane which is parallel with the upper surface of the substrate and <002>-oriented.

Magnetic anisotropic energy of the magnetic layers may be greater than that of the seed layers.

According to another aspect of the present invention, there is provided a method of manufacturing a magnetic recording medium, including: providing a substrate which has a upper and a lower surfaces and a thickness; forming a lower layer on the supper surface of the substrate; forming a template on the lower layer, said template being provided with a plurality of holes which expose parts (“exposed parts”) of the lower layer; forming seed layers which each cover the exposed parts of the lower layer, said seed layers having a thickness which is smaller than height of the holes; and forming magnetic layers on the seed layers in the holes, said magnetic layers filling the holes.

The substrate may be a silicon substrate, a glass substrate, or an aluminum alloy substrate.

The seed layers may be formed of a magnetic material selected from the group consisting of CoP, CoB, NiP, and NiB, or a nonmagnetic material selected from the group consisting of Cu, Ag, Au, Ni, and Pd.

The lower layer may be a laminate of a soft magnetic layer and an interlayer, which are stacked in turn.
The interlayer may be formed of Ti, Ru, Pt, Cu, or Au. The interlayer may have an HCP or FCC structure. In one exemplary embodiment, the interlayer may have an HCP having a (002) plane which is parallel with the upper surface of the substrate. In another exemplary embodiment, the interlayer may have an FCC having a (111) plane which is parallel with the upper surface of the substrate.

The lower layer may be a single layer or a dual layer. In one exemplary embodiment, the seed layers are formed of a nonmagnetic material which is exemplified above and the lower layer may be formed of a soft magnetic layer.

The seed layers may be formed to have a thickness between 1 nm and 30 nm. The seed layers may have a plane which is parallel with the upper surface of the substrate and is HCP (002)-oriented or FCC (111)-oriented.

The magnetic layers may be formed of CoNiP, CoPt, CoPtP, CoPtB, CoCrPt, CoCrTa, or CoCrNb.

The magnetic layers may be a multilayer formed of Co/Pt or Co/Pd.

The magnetic layers may be formed of CoPt or FePt which has an L1₀ structure.

The magnetic layers may be formed to have a thickness between 10 nm and 100 nm. The magnetic layers may have an HCP structure and a plane which is parallel with the upper surface of the substrate and has a preferred orientation toward an orientation <002>.

Magnetic anisotropic energy of the magnetic layers may be greater than that of the seed layers.

The seed layers may be formed using an electroless plating method. The magnetic layers may be formed using an electroplating method. A magnetic field may be applied in a direction perpendicular to the upper surface of the substrate, during the formation of the magnetic layers.

In order to catalyze the formation of the seed layers, a catalytic nucleus may be formed on the lower layer, prior to or after the formation of the template. When the catalytic nucleus is formed after the formation of the template, the catalytic nucleus formation is performed prior to the formation of seed layers.
The catalytic nucleus may be a noble metal.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a conventional magnetic recording medium;

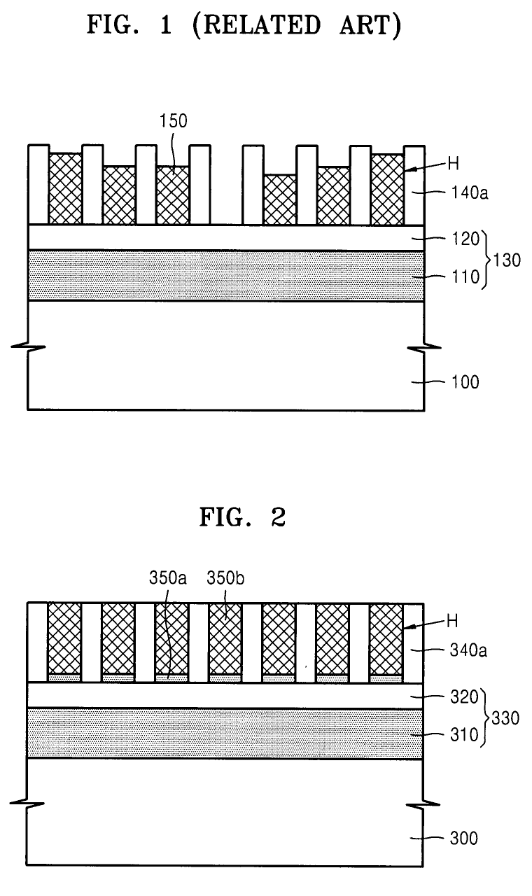

FIG. 2 is a cross-sectional view illustrating a magnetic recording medium according to an exemplary embodiment of the present invention; and

FIGS. 3A through 3D are cross-sectional views illustrating a method of manufacturing the magnetic recording medium illustrated in FIG. 2, according to an exemplary embodiment of the present invention.

### DETAILED DESCRIPTION OF THE INVENTION

Hereinafter, a method of manufacturing a magnetic layer, a patterned magnetic recording medium including thus formed magnetic layers, and a method of manufacturing the patterned magnetic recording medium according to embodiments of the present invention will be described in detail with reference to the attached drawings. The method of forming the magnetic layer will be described together with the method of manufacturing the magnetic recording medium.

In the drawings, the widths and thicknesses of layers and regions are exaggerated for clarity. Like reference numerals in the drawings denote like elements, and thus their description will be omitted.

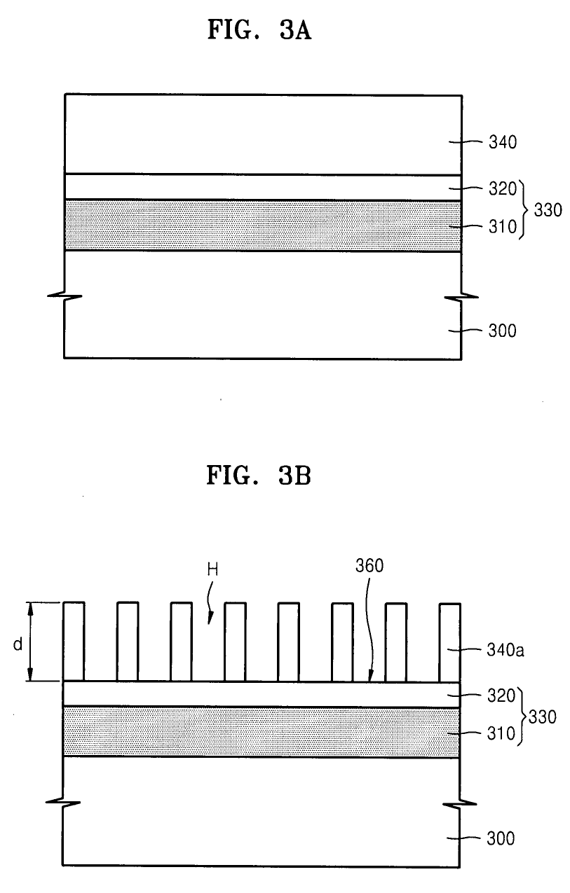

FIG. 2 is a cross-sectional view illustrating a magnetic recording medium including patterned magnetic layers according to an exemplary embodiment of the present invention. Referring to FIG. 2, a lower layer 330 is formed on a substrate 300, and a template 340a is formed on the lower layer 330. A plurality of holes H are formed in the template 340a so as to expose parts (“exposed parts”) of the lower layer 330. The substrate 300 may be a silicon substrate, a glass substrate, or an aluminum alloy substrate. The lower layer 330 may have a structure in which a soft magnetic layer 310 and an interlayer 320 are stacked in turn. The soft magnetic layer 310 may be formed of CoZrNb, NiFe, NiFeMo, or CoFeNi and have a thickness between 5 nm and 100 nm. The interlayer 320 may be a nonmagnetic layer. The interlayer 320 may be a metal layer having a hexagonal close packed (HCP) structure or a face centered cubic (FCC) structure. For example, the interlayer 320 may be formed of Ti, Ru, Pt, Cu, or Au and have a thickness of several to tens nanometers. The interlayer 320 also may have a HCP (002)-oriented plane which has a smaller lattice parameter mismatch than the seed layers and magnetic layers. Or, the interlayer 320 may have a FCC (111)-oriented plane which is equivalent to the HCP (002). Such orientation of the interlayer 320 may improve orientation characteristics of seed layers 350a and magnetic layers 350b, which are formed on the interlayer 320.

The seed layers 350a are formed onto bottoms of the holes H, i.e., on the parts (“exposed parts”) of the interlayer 320, which are exposed through the holes H. The seed layers 350a may be formed using an electroless plating method. The seed layers 350a may be magnetic layers formed of CoP, CoB, NiP, or NiB or nonmagnetic layers formed of Cu, Ag, Au, Ni, or Pd. The seed layers 350a may have a thickness between 1 nm and 30 nm. The seed layers 350 may have a HCP (002) or FCC (111) orientation in the direction parallel to an upper surface of substrate 300. In one exemplary embodiment, the seed layers 350a are nonmagnetic layers, and the interlayer 320 is omitted. In this case, the lower layer 330 may include the soft magnetic layer 310 only. The magnetic layers 350b are formed on the seed layers 350a so as to fill up the holes H. The top surfaces of the magnetic layers 350b locate at the same planar surface regardless of the location of the holes on the magnetic layers 350b. The magnetic layers 350b are formed using an electroplating method. The magnetic layers 350b may be magnetic layers formed of CoNiP, CoPt, CoPtP, CoPtB, CoCrPt, CoCrTa, or CoCrNb. The magnetic layers 350b may be formed of CoPt or FePt, which has a body centered tetragonal (BCT) structure, for example, LiO structure. The magnetic layers 350b may be a multilayer formed of Co/Pt or Co/Pd. The magnetic layers 350b may have a thickness between 10 nm and 100 nm. The magnetic layers 350b have an HCP structure and planes which are parallel with the upper surface of the substrate 300 and <002>-orientated-, thereby the magnetic layers 350b show perpendicular magnetization anisotropic properties. Magnetic anisotropic energy of the magnetic layers 350b is greater than that of the seed layers 350a.

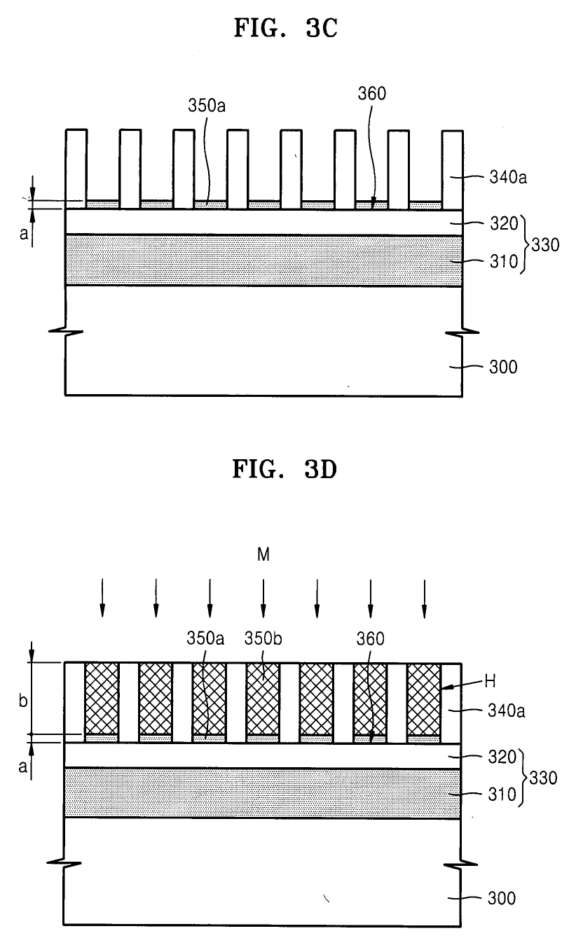

To improve bonding between the substrate 300 and the lower layer 330, the magnetic recording medium may include an additional seed layer (not shown). The seed layer for adhesion may be formed of Ta, Cr, or Ti using a deposition method, e.g., a sputtering method. The seed layer for adhesion may have a thickness between 5 nm and 20 nm.
A method of manufacturing the above-described magnetic recording medium will now be described with reference to FIGS. 3A through 3D.

Referring to FIG. 3A, the lower layer 330 is formed on the substrate 300, and a resin layer 340, e.g., a photoresist layer is coated on the lower layer 330. The lower layer 330 may be a laminate of the soft layer 310 and the interlayer 320, which are stacked in turn. A seed layer (not shown) may be formed between the substrate 300 and the lower layer 330 to a thickness between 5 nm and 20 nm. The seed layer may be formed of Ta, Cr, or Ti using a sputtering method.

Referring to FIG. 3B, the resin layer 340 is patterned to form a template 340a. The template 340a is a nonmagnetic layer and includes the plurality of holes H which expose parts 360 (“exposed parts”) of the lower layer 330. The holes H have a depth (d) which is smaller than or equivalent to the thickness of the template resin layer 340a. To form the template 340a, a photoresist layer may be coated on the lower layer 330 and then patterned using known methods, for example, electronic beam lithography, lithography using interference of ultraviolet or laser, natural lithography using anodic oxidization or diblock copolymers, or nano sphere lithography using nano-grains. Also, the template 340a may be formed using nanoimprinting.

The nanoimprinting refers to a nano patterning method which includes manufacturing a master stamp using one of the above-mentioned lithographies, coating a resin layer such as a photoresist layer on the lower layer 330, imprinting the resin layer using the master stamp, and patterning the resin layer on a nano scale.

The nanoimprinting is simple and economical and thus appropriate for mass-productions. However, if the plurality of holes H are formed using the nanoimprinting, portions of the resin layer may remain on bottoms of the plurality of holes H. The portions of the resin layer left on the bottoms of the plurality of holes may be removed using reactive ion etching (RIE) or plasma ashing.

Referring to FIG. 3C, the seed layers 350a are formed on the bottoms of the plurality of holes H. The bottom of the plurality of holes H are the exposed parts 360 of the lower layer 330. The seed layers 350a may be formed using an electroless plating method. The seed layers 350a may be formed to have a thickness (a) which is smaller than the depth (d) of the holes H. For example, the seed layer 350 may have a thickness (a) of 1-30 nm.

An electrolyte used in the electroless plating method may contain salts of a metal, which is to be plated and a reductant. It may further contain auxiliary components including a pH regulator, a buffer, a complexing agent, etc. For example, when the electroless plating method is used to form an Ni seed layer, the electrolyte may contain NiCl₂ or NiSO₄ as metallic salts, and NaH₂PO₂, NaBH₄, or Hydrazine:N₂H₄ as a reductant.

The electroless plating renders a formation of a metal plate on the lower layer 330 through a chemical reaction between the electrolyte contained in the electroless plating composition and the lower layer 330 which is formed on a substrate 300, without applying an external current to the substrate 300. Therefore, a resulted plate, that is, the seed layers 350a in one exemplary embodiment as shown in FIG. 3C have a uniform thickness regardless where they are formed. Also, unlike an electroplating method which produces by-products, the electroless plating method does not generate by-products such as hydrogen, and, thus, steps of discharging by-products may be omitted.

An uniform seed layers 350a may be obtained using the electroless plating method, even when the portions of the resin layer remain on the bottoms of the holes H. Thus, if the seed layers 350a are formed using the electroless plating method, a step of removing the remaining portions of the resin layer using RIE or plasma ashing may be omitted.

To accelerate the electroless plating, a catalytic nucleus may be formed on an entire upper surface of the lower layer 330, after the lower layer 330 may be formed and before the resin layer 340 is formed. When the lower layer 330 includes a soft magnetic layer 310 and an interlayer 320, the catalytic nucleus may be formed on the upper surface of the interlayer 320. The catalytic nucleus may be formed of a noble metal such as Pd. Alternatively, the catalytic nucleus may be formed after a template 340 is formed on the interlayer 320 but before forming the seed layer 350a. In this case, the catalytic nucleus is formed on parts (exposed parts) of the interlayer 320, where the surface of the interlayer 320 is exposed through the holes H.

Referring to FIG. 3D, the magnetic layers 350b are formed on the seed layers 350a to have a thickness (b) to fill up the holes H by inserting magnetic materials into the holes H. The magnetic layers 350b may be formed using an electroplating method. While the electroplating method is performed, an external magnetic field M may be applied in a direction perpendicular to the upper surface of the substrate 300.

A planarizing process, e.g., a chemical mechanical polishing (CMP) or burnishing, may be performed to planarize surfaces of the resulting patterned magnetic layers 350b. An anti-corrosion protection layer (not shown) may be on the template 340a and the magnetic layers 350b, followed by coating with a lubricant. The anti-corrosion protection layer may be formed of, for example, diamond-like carbon (DLC).

As described above, in the present invention, the patterned magnetic layers 350b are formed on the seed layers 350a to have an uniform thickness. Thus, the uniformity of thicknesses and micro structures of the patterned magnetic layers 350b may be improved.

Also, before the magnetic layers 350b are formed, the seed layers 350a may be formed using the electroless plating method. This allows a formation of uniform seed layers 350 in each individual hole H. Thus, the total heights of the seed layers 350a and the magnetic layers 350b, which fill up the respective individual holes H, are uniform regardless where the holes H are located on the substrate 300.

In addition, the magnetic layers 350b have the HCP structure and are formed to have planes which are parallel with the upper surface plane of the substrate 300 and <200>-orientated. As a result, the orientation characteristics of the magnetic layers 350b, which are used as data recording layers, are improved, and thus the perpendicular magnetic anisotropic properties and magnetization reverse properties of the patterned magnetic layers 350b may be improved. Moreover, the patterned magnetic layers 350b, which are formed while an external magnetic field M is applied in a direction perpendicular to the upper surface of the substrate 300, have improved orientation properties and magnetic properties.

To improve reading and writing characteristics and a recording density of a magnetic recording medium, magnetization orientation of magnetic domains may be reversed by a coherent rotation. For this purpose, the magnetic layers 350b corresponding to bit sizes may have the HCP structure and (002) planes which are parallel with the upper surface of the substrate 300. Also, the magnetic layers 350b are required to have appropriate thicknesses, aspect ratios and uniform micro structures.

The patterned magnetic layers 350b of the present invention may satisfy the above conditions. Thus, a magnetic recording medium including the magnetic layers 350b according to the present invention may have good reading and writing characteristics and a high recording density of 1 Tb/in² or higher.

In addition, uniform seed layers 350a may be formed using an electroless plating method, even when portions of the resin layer 340 remain on the bottoms (i.e., exposed parts 360) of the holes H after the nanoimprinting process to form a template 340a, leaving an uneven bottom surface. Therefore, an additional process of removing the portions of the resin layer left on the bottoms of the holes H is not required. As a result, the process may be shortened and simplified.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a magnetic layer, comprising: forming a template provided with an opening, said template having an upper and a lower surfaces and a thickness;
forming a seed layer on a bottom of the opening, said seed layer having a thickness which is smaller than the depth of the opening; and
inserting a magnetic material onto the seed layer in the opening to form a magnetic layer.

2. The method of claim 1, wherein the opening is a through hole.

3. The method of claim 1, wherein the seed layer is formed of a magnetic material selected from the group consisting of CoP, CoB, NiP, and NiB or a nonmagnetic material selected from the group consisting of Cu, Ag, Au, Ni, and Pd.

4. The method of claim 1, wherein the thickness of the seed layer is between 1 nm and 30 nm.

5. The method of claim 1, wherein the magnetic material is one selected from the group consisting of CoNiP, CoPt, CoPtP, CoPtB, CoCrPt, CoCrTa, and CoCrNb.

6. The method of claim 1, wherein the magnetic layer is formed of one of Co/Pt and Co/Pd.

7. The method of claim 1, wherein the magnetic layer is formed of one of CoPt and FePt which has an L1₀ structure.

8. The method of claim 1, wherein the magnetic layer is formed to a thickness between 10 nm and 100 nm.

9. The method of claim 1, wherein magnetic anisotropic energy of the magnetic layer is greater than that of the seed layer.

10. The method of claim 1, wherein the seed layer has a plane which is parallel with the upper surface of the template and is hexagonal close packed (HCP) (002)-oriented or face centered cubic (FCC) (111)-oriented.

11. The method of claim 1, wherein the magnetic layer has an HCP structure and comprises a plane which is parallel with the upper surface of the template and is <002>-preferred oriented.

12. The method of claim 1, wherein the seed layer is formed using an electroless plating method.

13. The method of claim 1, wherein the magnetic layer is formed using an electroplating method.

14. The method of claim 13, which further comprises applying a magnetic field in a direction perpendicular to a surface of the bottom of the opening, when the magnetic layer is formed.

15. The method of claim 1, which further comprises forming a catalytic nucleus on the bottom of the opening, prior to the formation of the seed layer.

16. The method of claim 15, wherein the catalytic nucleus is formed of a noble metal.

17. A magnetic recording medium comprising:
a substrate having a upper surface, a lower surface, and a thickness;
a lower layer formed on the upper surface of the substrate;
a template formed on the lower layer and comprising a plurality of holes which expose parts (“exposed parts”) of the lower layer;
seed layers which each cover the exposed parts of the lower layer, said seed layers having a thickness which is smaller than height of the holes; and
magnetic layers formed on the seed layers in the holes, said magnetic layers filling the holes.

18. The magnetic recording medium of claim 17, wherein the substrate is one of a silicon substrate, a glass substrate, and an aluminum alloy substrate.

19. The magnetic recording medium of claim 17, wherein the seed layers are formed of a magnetic material selected from the group consisting of CoP, CoB, NiP, and NiB or a nonmagnetic material selected from the group consisting of Cu, Ag, Au, Ni, and Pd.

20. The magnetic recording medium of claim 17, wherein the lower layer is a laminate layer in which a soft magnetic layer and an interlayer are stacked in turn.

21. The magnetic recording medium of claim 20, wherein the interlayer is formed of one of Ti, Ru, Pt, Cu, and Au.

22. The magnetic recording medium of claim 20, wherein the lower layer has one of HCP and FCC structures.

23. The magnetic recording medium of claim 22, wherein the interlayer has an HCP structure which has a (002) plane, said (002) plane being parallel with an upper surface of the substrate.

24. The magnetic recording medium of claim 22, wherein the interlayer has an FCC structure which has a (111) plane, said (111) plane being parallel with the upper surface of the substrate.

25. The magnetic recording medium of claim 19, wherein the seed layers are formed of the nonmagnetic material, and the lower layer is a soft magnetic layer.

26. The magnetic recording medium of claim 17, wherein the thickness of the seed layers is between 1 nm and 30 nm.

27. The magnetic recording medium of claim 17, wherein the seed layers have a plane which is parallel with the upper surface of the substrate and is HCP (002)-oriented or FCC (111)-oriented.

28. The magnetic recording medium of claim 17, wherein the magnetic layers are formed of one of CoNiP, CoPt, CoPtP, CoPtB, CoCrPt, CoCrTa, and CoCrNb.

29. The magnetic recording medium of claim 17, wherein the magnetic layers are formed of one of Co/Pt and Co/Pd.

30. The magnetic recording medium of claim 17, wherein the magnetic layers are formed of one of CoPt and FePt which has an L1₀ structure.

31. The magnetic recording medium of claim 17, wherein the magnetic layers have a thickness between 10 nm and 100 nm.

32. The magnetic recording medium of claim 17, wherein the magnetic layers have an HCP structure and a plane which is parallel with the upper surface of the substrate, said plane being <002>-oriented.

33. The magnetic recording medium of claim 17, wherein magnetic anisotropic energy of the magnetic layers is greater than that of the seed layers.

34. A method of manufacturing a magnetic recording medium, comprising:
providing a substrate which has a upper and a lower surfaces and a thickness;
forming a lower layer on the supper surface of the substrate;
forming a template on the lower layer, said template being provided with a plurality of holes which expose parts (“exposed parts”) of the lower layer;
forming seed layers which each cover the exposed parts of the lower layer, said seed layers having a thickness which is smaller than height of the holes; and
forming magnetic layers on the seed layers in the holes, said magnetic layers filling the holes.

35. The method of claim 34, wherein the substrate is one of a silicon substrate, a glass substrate, and an aluminum alloy substrate.

36. The method of claim 34, wherein the seed layers are formed of a magnetic material selected from the group consisting of CoP, CoB, NiP, and NiB or a nonmagnetic material selected from the group consisting of Cu, Ag, Au, Ni, and Pd.

37. The method of claim 34, wherein the lower layer is formed of a soft magnetic layer and an interlayer, which are stacked in turn.

38. The method of claim 37, wherein the interlayer is formed of one of Ti, Ru, Pt, Cu, and Au.

39. The method of claim 37, wherein the interlayer has one of HCP and FCC structures.

40. The method of claim 39, wherein the interlayer has an HCP structure which has a (002) plane, said (002) plane being parallel with the upper surface of the substrate.

41. The method of claim 39, wherein the interlayer has an FCC structure which has a (111) plane, said (111) plane being parallel with the upper surface of the substrate.

42. The method of claim 34, wherein the lower layer is one of a single layer and a dual layer.

43. The method of claim 36, wherein the seed layers are formed of the nonmagnetic material, and the lower layer is formed of a soft magnetic layer.

44. The method of claim 34, wherein the seed layers are formed to a thickness between 1 nm and 30 nm.

45. The method of claim 34, wherein the seed layers have a plane which is parallel with the upper surface of the substrate, said plane being HCP (002)-oriented or FCC (111)-oriented.

46. The method of claim 34, wherein the magnetic layers are formed of one of CoNiP, CoPt, CoPtP, CoPtB, CoCrPt, CoCrTa, and CoCrNb.

47. The method of claim 34, wherein the magnetic layers are formed of one of Co/Pt and Co/Pd.

48. The method of claim 34, wherein the magnetic layers are formed of one of CoPt and FePt which has an L1₀ structure.

49. The method of claim 34, wherein the magnetic layers are formed to a thickness between 10 nm and 100 nm.

50. The method of claim 34, wherein the magnetic layers have an HCP structure and a plane, said plane being parallel with the upper surface of the substrate and <002>-preferred oriented.

51. The method of claim 34, wherein magnetic anisotropic energy of the magnetic layers is greater than that of the seed layers.

52. The method of claim 34, wherein the seed layers are formed using an electroless plating method.

53. The method of claim 34, wherein the magnetic layers are formed using an electroplating method.

54. The method of claim 53, which further comprises applying a magnetic field in a direction perpendicular to the upper surface of the substrate, when the magnetic layers are formed.

55. The method of claim 34, which further comprises forming a catalytic nucleus on the lower layer, prior to the formation of the template.

56. The method of claim 34, which further comprises forming a catalytic nucleus on the exposed parts of the lower layer, after the template is formed and before the seed layers are formed.

57. The method of claim 55, wherein the catalytic nucleus is a noble metal.

58. The method of claim 56, wherein the catalytic nucleus is a noble metal.
